(19) United States
(12) Patent Application Publication
(10) Pub. No.: US 2019/0038483 A1
(43) Pub. Date: Feb. 7, 2019

(54) WHEELCHAIR SUPPORT AND LIFTING DEVICE

(71) Applicant: FREEDOM BAR, LLC, Atlanta, GA (US)

(72) Inventor: David L. Bremseth, Plymouth, MN (US)

(21) Appl. No.: 16/074,000

(22) PCT Filed: Jan. 30, 2017
(86) PCT No.: PCT/US2017/015688

§ 371 Date: Jul. 30, 2018

Related U.S. Application Data
(60) Provisional application No. 62/291,255, filed on Feb. 4, 2016.

(51) Int. Cl. A61G 3/06

(52) U.S. Cl. CPC A61G 3/062

(57) ABSTRACT

An apparatus includes a support member having first and second ends. A door member is coupled to the support member and positioned on the first end. The door member is sized and shaped to fit over and removably couple to a top side of a vehicle door. A roof member is coupled to the support member and positioned on the second end. The roof member is sized and shaped to one of: fit over a vehicle roof rack, rest on a vehicle roof, and couple to a securing structure positioned on a vehicle roof.

### BACKGROUND

Getting into and out of a vehicle is challenging for wheelchair users. Such activity typically requires another person to assist with moving a person into or out of the vehicle and also assembling or disassembling the wheelchair for use or storage. Many wheelchair users are thus dependent on another person for transportation.

Some wheelchair users address such challenges to their independence by purchasing a specially-designed but expensive vehicle that features a powered lift, which simultaneously moves the wheelchair and user into and out of the vehicle. Other approaches involve expensive modifications to vehicles by retrofitting various contraptions that move both the user and wheelchair. These approaches are not only expensive but also permanent or semi-permanent (e.g., bolted) and limit the types of vehicles that can be used. Other, perhaps less expensive, approaches focus on moving the user—but not the wheelchair—which still requires another person to help with storing or unpacking the wheelchair.

### SUMMARY

Accordingly, certain embodiments of the present disclosure involve devices and methods for assisting with moving a wheelchair into and out of vehicles.

In Example 1, an apparatus for removably coupling to a vehicle includes a support member having first and second ends. The apparatus further includes a door member coupled to the support member and positioned on the first end. The door member is sized and shaped to fit over and removably couple to a top side of a vehicle door. A roof member is coupled to the support member and positioned on the second end. The roof member is sized and shaped to one of: fit over a vehicle roof rack, rest on a vehicle roof, and couple to a securing structure positioned on a vehicle roof.

In Example 2, the apparatus of Example 1, further including a pulley coupled to the support member and positioned between the first and second ends.

In Example 3, the apparatus of Example 2, wherein the pulley is a high-leverage pulley.

In Example 4, the apparatus of any of Examples 2-3, wherein the pulley is movable along the support member.

In Example 5, the apparatus of any of Examples 2-4, wherein the pulley is a powered pulley.

In Example 6, the apparatus of any of Examples 1-5, wherein the support member is a telescoping support member.

In Example 7, the apparatus of any of Examples 1-6, wherein the support member includes a hinge.

In Example 8, the apparatus of any of Examples 1-7, wherein the support member has a flat surface on a bottom-side of the support member facing a vehicle roof.

In Example 9, the apparatus of any of Examples 1-8, wherein the door member includes a slip-resistant material.

In Example 10, the apparatus of Example 9, wherein the slip-resistant material is rubber.

In Example 11, the apparatus of Example 9, wherein the door member is U-shaped and wherein the slip-resistant material is positioned to contact a top side of a vehicle door.

In Example 12, the apparatus of any of Examples 1-11, wherein the roof member is U-shaped.

In Example 13, the apparatus of any of Examples 1-12, wherein roof member includes a protrusion for coupling to the securing structure.

In Example 14, the apparatus of any of Examples 1-13, wherein the roof member includes teeth for coupling to the securing structure.

In Example 15, the apparatus of any of Examples 1-14, wherein the roof member is removably coupled to the support member.

In Example 16, the apparatus of Example 1, wherein the roof member forms a sleeve around the support member and wherein the roof member forms a flat surface facing a vehicle roof's top surface.

In Example 17, the apparatus of any of Examples 1-16, wherein the roof and/or door member comprises a magnet.

In Example 18, the apparatus of Examples 1-17, wherein the support member comprises multiple pieces coupled together.

In Example 19, the apparatus of any of Examples 1-18, wherein the door member is shaped and sized to fit over a corner of the vehicle door.

In Example 20, a wheelchair lifting device is adapted to extend between a vehicle door and roof. The device includes a support member for extending between a vehicle door and roof, the support member including first and second ends. The device further includes a first securing means for removably coupling the first end to a vehicle door and a second securing means for removably coupling the second end to a vehicle roof.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

FIG. 1 shows an exploded view of a wheelchair support and lifting device, in accordance with certain embodiments of the present disclosure.

FIG. 2 shows a top view of the wheelchair support and lifting device of FIG. 1.

FIG. 3 shows a side view of a support member and door member, in accordance with certain embodiments of the present disclosure.

FIGS. 4A-D show side views of a support member and roof member, in accordance with certain embodiments of the present disclosure.

FIG. 5 shows a side view of a support member and securing structure, in accordance with certain embodiments of the present disclosure.

### DETAILED DESCRIPTION

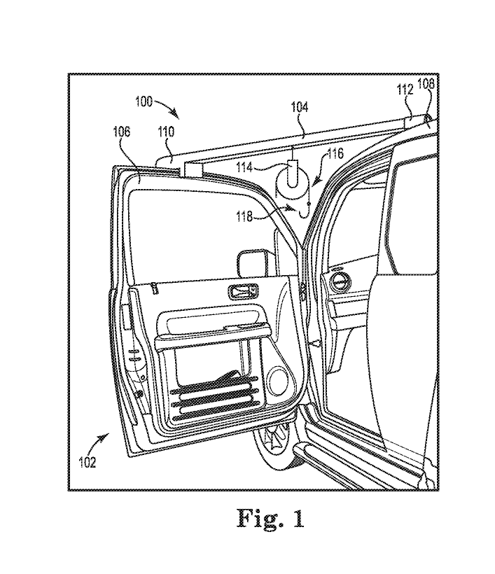

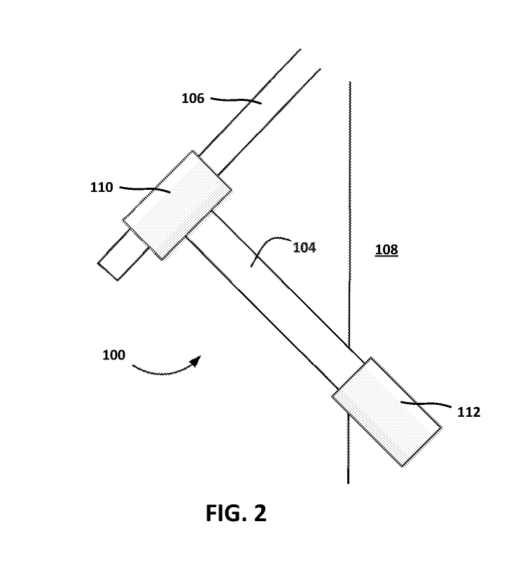

FIG. 1 shows a device 100 for use with a vehicle 102 to assist with moving a wheelchair into and out of a variety of vehicle types and models. FIG. 2 shows a top schematic view of the device 100. The device 100 includes a support member 104 that extends between a vehicle door 106 and roof 108. The support member 104 is portable and is removably (e.g., not permanently) coupled to the vehicle. FIG. 1 shows the support member 104 having a door member 110 positioned on one end of the member and a roof member 112 positioned on the opposite end. The door member 110, which will be described in further detail below, is shaped and sized to removably couple and fit to the vehicle door 106. The roof member 112 can be shaped and sized for a variety of positions and coupling configurations with the vehicle roof 108, as will be described in further detail below.

For using the device 100 to get out of the vehicle 102, a user would open the vehicle door 106 to the door's most-open position. The user could then couple the door member 110 to a top of the vehicle door 106 and also couple the roof member 112 to the vehicle roof 108 or other structure positioned on the roof. Once coupled, the support member 104 would extend between the door and roof. In certain embodiments, the support member 104 includes a pulley 114 mounted to the support member between the door member and roof member. The pulley 114 can be coupled in a removable, permanent, movable, and/or slidable manner to the support member. If removably coupled, the user could couple the pulley 114 to the support member before or after the member is positioned to extend between the vehicle door and roof. For example, the pulley may have a hook or other attachment means for attaching and positioning the pulley to the support member. If slidably coupled, the user could slide the pulley to a desired position and then lock the pulley in place.

For use with the pulley 114, the device 100 may include a rope, chain, cord, line or similar feature 116 that is shaped (e.g., looped) such that the wheelchair can be connected on one end of the rope, chain, cord 116. In some embodiments, an attachment mechanism 118 is attached to the rope 116 for connecting to the wheelchair. The attachment mechanism 118 could include a hook, carabiner, or similar mechanism that permits the user to easily attach and detach the wheelchair to and from the mechanism.

Once the user attaches the wheelchair, the user could complete assembly of the wheelchair, if needed, while the wheelchair is suspended above the ground. Once assembled for use, the wheelchair can be lowered to the ground by using the pulley. The pulley 114 can be one of or a combination of a ratchet pulley to assist with maintaining a vertical position, a leveraged pulley to reduce force needed to lower or raise the wheelchair, and a powered pulley that can be used without the user physically raising and lowering the wheelchair. A powered pulley, for example, may be powered by electrically coupling the pulley to a vehicle's electrical outlet or cigarette lighter.

Once the wheelchair is positioned on the ground, the user may move themselves into the wheelchair and unmount the pulley 114 and/or support member 104. The support member 104 may comprise lightweight materials such as aluminum or carbon fiber so that the user can easily couple and uncouple the support member to and from the vehicle. The support member 104 can have a variety of cross section shapes (e.g., circle, hollow, square, rectangular) and is not limited to a solid cylindrical cross section or even symmetrical cross sections. For example, as will be shown in later figures, the support member may feature a cross section that is semi-circle shaped such that the support member includes a flat bottom surface. A flat surface provides a stable surface so that the support member does not rock or rotate during use. In some embodiments, the support member may feature various mechanisms such as holes, latches, and notches for attaching or positioning other components like pulleys. In certain embodiments, the device 100 may feature a structure extending between a vehicle's door and roof that is not necessarily member-shaped. For example, a supporting structure may have a significant bow such that a middle portion of the structure is positioned significantly lower than either end. In certain embodiments, the support member comprises multiple pieces coupled together to form the support member.

In certain embodiments, the support member 104 includes at least one hinge to permit the member to be folded for more compact storage. In certain embodiments, the support member 104 is structured to telescope such that a length of the support member can be decreased for more compact storage. Regardless of whether the support member 104 is hinged or telescoped, the user can store the support member and other features in the vehicle. For getting into the vehicle, the steps described above can be repeated in reverse.

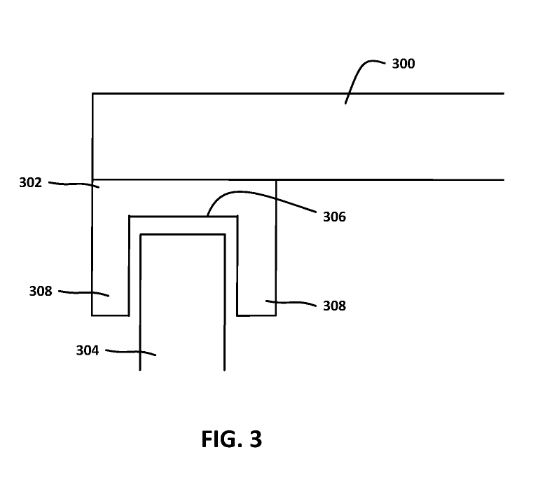

FIG. 3 shows a side view of a support member 300 and door member 302 positioned on top of a vehicle door 304. The support member 300 has a flat bottom surface 304 that faces downwards towards the vehicle door 304. Although the support member 300 and door member 302 are shown as separate components directly attached to each other, they may be integral with each other or indirectly attached. Further, the door member 302 may be permanently or removably coupled to the support member 300. For example, the door member 302 and support member 300 may be coupled together by threads or similar means so that the door member can be replaced, stored, etc.

The door member 302 can be U-shaped such that the member fits over a top of the vehicle door. Although FIG. 3 shows the door member 304 uncoupled to the vehicle door 304, in use, the door member 304 would be contactingly engaged with the vehicle door. For example, a bottom surface 306 of the door member (or the entire door member) can comprise a slip-resistant material that contacts the vehicle door. In use, the weight of the support member and wheelchair coupled with friction between the slip-resistant material and vehicle door helps keep the support member positioned. In some embodiments, door members are shaped to hook around a top of the vehicle door and through a vehicle window opening. In some embodiments, door members may be shaped to fit over a corner of a door. This configuration may help with ensuring that the door member does not slide along a top of the door.

The U-shaped door member 302 includes legs 308 that may also include a slip-resistant material to help maintain the position of the support member. The legs 308 may also or solely include a soft and/or scratch-resistant material such that the door member 302 does not damage the vehicle door during use. Although FIG. 3 shows legs 308 not contacting the vehicle door 304, in certain embodiments the legs may contact the door to provide additional assistance with maintaining the support member's position.

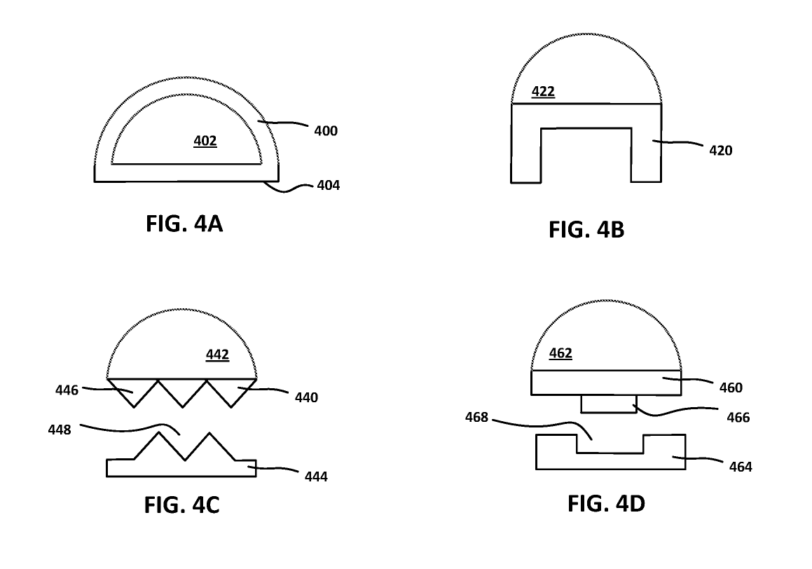

FIGS. 4A-D show a variety of configurations of a roof member. The roof member may be permanently or removably coupled to a support member. Removable roof members, for example, may include threads or other attachment means that would permit the member to be attached and detached from the support such that different roof members could be used with the support member.

FIG. 4A shows a roof member 400 arranged as a sleeve that fits over an end of a support member 402. In this embodiment, the member is shaped and sized to rest on a vehicle roof. For example, the member may have a pliable surface 404 that conforms to a shape of a vehicle roof. In other embodiments, the roof member is not a sleeve and attached to a bottom side of the support member 402. The member may include a slip-resistant material that helps maintain a position of the support member with respect to the vehicle roof.

FIG. 4B features a roof member 420 attached to or integral with an end of a support member 422. In this embodiment, the roof member 420 is shaped and sized to fit over a roof rack in a similar manner as described with the door member shown in FIG. 3. The roof member 420 is shown as being U-shaped to permit the roof member to rest on or couple to a roof rack. The member may include a slip-resistant material that helps maintain a position of the support member with respect to the vehicle roof rack.

FIG. 4C features a roof member 440 attached to or integral with an end of a support member 442. In this embodiment, the roof member 440 is shaped and sized to join with a securing structure 444 that is positioned on a vehicle roof. For example, the roof member 440 is shaped to have teeth 446 that are configured to fit into corresponding gaps 448 of the securing structure 444. Engaging the teeth 446 with corresponding gaps 448 can assist with maintaining a position of the support member 442 with respect to a vehicle roof. This may be particularly helpful for using the support member after or during rain or snow. Moreover, the teeth and gap configuration may provide the user confidence that the roof-end of the support member has been secured to the vehicle.

FIG. 4D features a roof member 460 attached to or integral with an end of a support member 462. In this embodiment, the roof member 460 is shaped and sized to join with a securing structure 464 that is positioned on a vehicle roof. For example, the roof member 460 includes a protrusion 466 that extends from a bottom surface of the member. The protrusion 466 is shaped to fit into a corresponding recess 468 formed by the securing structure 464. Engaging the protrusion 464 with corresponding gaps 468 can assist with maintaining a position of the support member 442 with respect to a vehicle roof. This may be particularly helpful for using the support member after or during rain or snow. Moreover, the protrusion and recess configuration may provide the user confidence that the roof-end of the support member has been secured to the vehicle. In some embodiments, members may feature one or more magnets that mate with one or more magnets positioned on securing structures. For example, the magnets may be coated with a soft or rubbery material that reduces potential damage to a vehicle's paint.

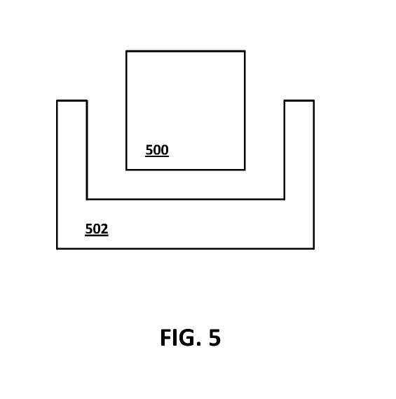

FIG. 5 features an end of a support member 500 and securing structure 502. Although the support member 500 is shown without a member or sleeve, the present embodiment may include such features. In this embodiment, the end of the support member 500 fits into the securing structure, which is shown as being U-shaped and which may be secured to a top of a vehicle roof. The support member rests in the securing structure, which helps maintain a position with respect to a vehicle roof. The support member may also include a larger diameter feature at a distal end of the support member to ensure that the support member does not slide out of the securing structure 502 in an axial direction. Applicant appreciates that other combinations and configurations of support members and securing structures can be used to maintain a position of the support member with respect to a vehicle roof.

The present disclosure is not limited for use in any specific type or model of vehicle. Moreover, feature of the present disclosure can be used with front or rear driver's side and passenger's side doors. For example, a support member may be used on a rear door to assist with someone, who is helping a wheelchair user, to move a wheelchair into and out of a vehicle. In such a case, a support member provided with a pulley may ease the physical strength needed to lift a wheelchair into a vehicle. Moreover, the support member may include a movable arm, instead of or in addition to a pulley, that a user could control to assist with raising and lowering a wheelchair into and out of a vehicle.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the above described features.

1. An apparatus for removably coupling to a vehicle, the apparatus comprising:
a support member having first and second ends;
a door member coupled to the support member and positioned on the first end, wherein the door member is sized and shaped to fit over and removably couple to a top side of a vehicle door; and
a roof member coupled to the support member and positioned on the second end, wherein the roof member is sized and shaped to one of: fit over a vehicle roof rack, rest on a vehicle roof, and couple to a securing structure positioned on a vehicle roof.

2. The apparatus of claim 1, further comprising:
a pulley coupled to the support member and positioned between the first and second ends.

3. The apparatus of claim 2, wherein the pulley is a high-leverage pulley.

4. The apparatus of claim 2, wherein the pulley is movable along the support member.

5. The apparatus of claim 2, wherein the pulley is a powered pulley.

6. The apparatus of claim 1, wherein the support member is a telescoping support member.

7. The apparatus of claim 1, wherein the support member includes a hinge.

8. The apparatus of claim 1, wherein the support member has a flat surface on a bottom-side of the support member facing a vehicle roof.

9. The apparatus of claim 1, wherein the door member includes a slip-resistant material.

10. The apparatus of claim 9, wherein the slip-resistant material is rubber.

11. The apparatus of claim 9, wherein the door member is U-shaped and wherein the slip-resistant material is positioned to contact a top side of a vehicle door.

12. The apparatus of claim 1, wherein the roof member is U-shaped.

13. The apparatus of claim 1, wherein roof member includes a protrusion for coupling to the securing structure.

14. The apparatus of claim 1, wherein the roof member includes teeth for coupling to the securing structure.

15. The apparatus of claim 1, wherein the roof member is removably coupled to the support member.

16. The apparatus of claim 1, wherein the roof member forms a sleeve around the support member and wherein the roof member forms a flat surface facing a vehicle roof's top surface.

17. The apparatus of claim 1, wherein the roof and/or door member comprises a magnet.

18. The apparatus of claim 1, wherein the support member comprises multiple pieces coupled together.

19. The apparatus of claim 1, wherein the door member is shaped and sized to fit over a corner of the vehicle door.

20. A wheelchair lifting device adapted to extend between a vehicle door and roof, the device comprising:
a support member for extending between a vehicle door and roof, the support member including first and second ends;
first securing means for removably coupling the first end to a vehicle door;
second securing means for removably coupling the second end to a vehicle roof; and
lifting means coupled to the support member.
